(19) United States
(12) Patent Application Publication
(10) Pub. No.: US 2015/0186596 A1
(43) Pub. Date: Jul. 2, 2015

(54) POPULATION CLASSIFICATION OF GENETIC DATA SET USING TREE BASED SPATIAL DATA STRUCTURE

(71) Applicant: KONINKLIJKE PHILIPS N.V., Eindhoven (NL)

(72) Inventors: Biswaroop Chakrabarti, Kolkata (IN); Prakash Muniyappa, Bangalore (IN); Sunil Kumar, Bangalore (IN); Randeep Singh, Bangalore (IN); Subodh Kumar, Bangalore (IN); Ashwatha Matthur, Bangalore (IN)

(73) Assignee: KONINKLIJKE PHILIPS N.V., Eindhoven (NL)

(21) Appl. No.: 14/416,647

(22) PCT Filed: Aug. 7, 2013
(86) PCT No.: PCT/IB2013/056453

§ 371 Date: Jan. 23, 2015

Related U.S. Application Data
(60) Provisional application No. 61/680,344, filed on Aug. 7, 2012.

(51) Int. Cl. G06F 19/18

(52) U.S. Cl. CPC G06F 19/18

(57) ABSTRACT

Reference feature vectors are constructed representing refer-ence genetic data sets of a reference population. The reference feature vec-tors are transformed using a linear transformation to generate reduced di-mensionality vector representations of the reference genetic data sets of the reference population. A tree-based spatial data structure is constructed to index the reference genetic data sets as data points defined by at least some dimensions of the reduced dimensionality vector representations of the ref-erence genetic data sets of the reference population. The linear transform may be generated by performing feature reduction on the reference feature vectors. A feature vector representing a proband genetic data set is trans-formed using the linear transformation to generate a reduced-dimensional-ity vector representation that is located in the tree-based spatial data struc-ture to perform population assignment for the proband genetic data set.

The following relates to the genetic analysis arts, medical arts, and to applications of same such as the medical arts including oncology arts, veterinary arts, and so forth.

Large genetic data sets can be acquired for individuals using technologies such as microarrays which are capable of generating tens to hundreds of thousands of genetic data points, e.g. each corresponding to the expression level of a target protein or the like, and “next generation” sequencing systems which are capable of outputting large sequences, and even whole genome sequences, constituting millions or more bases. From such a data set, various genetic markers such as single nucleotide polymorphisms (SNPs), copy number variations (CNVs) etc. can be identified which are medically probative, for example being indicative of a particular type of cancer.

It is known that the interpretation of such genetic markers is facilitated by, or in some cases even requires, knowledge of classification of the individual by ethnicity, gender, or some other population grouping. For example, some genomic variants (note that, as used herein, “genetic” and “genomic” are considered interchangeable) have been associated with more than one different genetic disorder, depending upon the population. In some cases, an allele is a major allele in one population and a minor (and disease-indicative) allele in another population. Thus, knowing the appropriate population is useful or even required for proper interpretation of genetic variants.

In some cases, a genetic dataset can be classified based on existing knowledge and/or observed phenotype. For example, the gender or ethnicity of a patient may be known or self-reported. However, this approach can be prone to error. Some classifications may also be unknown to the subject and treating medical personnel. For example, a patient may unknowingly belong to a population group defined by an undiagnosed medical condition or by a genetic signature indicative of propensity for a particular disease. Proper identification of population is of importance in disease management also as some treatments may differ in efficacy between populations. Moreover, the genetic data set may not be labeled with available classification information due to clerical error or omission, or personal privacy or cultural sensitivity considerations.

Assignment of a genetic data set to a population can alternatively be based on population-specific genetic markers such as genotypes, expression/methylation status, and so forth. This approach advantageously derives the population grouping information from the genetic data set itself.

When performing genetic analysis on a new individual, the acquired genetic data set is subjected to this population classification. Similarly, when performing a genetic analysis of a sub-population within a population of individuals, such classification is again a preliminary operation. Population classification of a genetic data set is typically a time consuming process, and must be performed for each new genetic data set under analysis (e.g., each new patient).

Moreover, population classification approaches that rely upon observing discrete genetic markers (e.g., specific population-indicative alleles) in the genetic data set do not make use of the complete genetic data set in the population classification process.

The following contemplates improved apparatuses and methods that overcome the aforementioned limitations and others.

According to one aspect, a non-transitory storage medium stores instructions executable by an electronic data processing device to perform a method comprising: performing feature reduction on feature vectors representing genetic data sets of a reference population to generate a mapping that maps the feature vectors to a vector space of reduced dimensionality as compared with the dimensionality of the feature vectors; generating reduced dimensionality vector representations of the genetic data sets of the reference population using the mapping; and storing the reduced dimensionality vector representations of the genetic data sets of the reference population as data points in a tree based spatial data structure. The mapping is suitably a linear transformation, and may be Y=M(X) where X is a feature vector representing a genetic data set, Y is the reduced-dimensionality vector representation of the genetic data set, and M is a transformation matrix. The feature reduction may employ principal component analysis (PCA). The method may further comprise: annotating the data points in the tree-based spatial data structure with information about subjects from which the genetic data sets of the reference population were acquired; and associating spatial regions of the tree-based spatial data structure with populations within the reference population based on the distribution of data points and their annotations, for example by performing clustering of the annotated data points in the space indexed by the tree-based spatial data structure. The method may further comprise: generating a proband reduced-dimensionality vector representation of a proband genetic data set using the mapping; locating the proband reduced-dimensionality vector representation in the tree-based spatial data structure; and classifying the proband genetic data set based on its location in the tree-based spatial data structure.

According to another aspect, an apparatus comprises a non-transitory storage medium as set forth in the immediately preceding paragraph, and an electronic data processing device configured to read and execute instructions stored on the non-transitory storage medium.

According to another aspect, a method comprises: constructing a feature vector representing a genetic data set; reducing dimensionality of the feature vector using a linear transformation to generate a reduced dimensionality vector representation of the genetic data set; locating the reduced dimensionality vector representation of the genetic data set in a tree based spatial data structure; and assigning the genetic data set to one or more populations based on the location of its reduced dimensionality vector representation in the tree based spatial data structure. At least the constructing, generating, and locating are suitably performed by an electronic data processing device.

According to another aspect, an apparatus comprises an electronic data processing device programmed to: construct reference feature vectors representing reference genetic data sets of a reference population; transform the reference feature vectors using a linear transformation to generate reduced dimensionality vector representations of the reference genetic data sets of the reference population; and construct a tree-based spatial data structure to index the reference genetic data sets as data points defined by at least some dimensions of the reduced dimensionality vector representations of the reference genetic data sets of the reference population. The linear transform may be generated by performing feature reduction on the reference feature vectors.

One advantage resides in more efficient population classification or grouping of a genetic data set.

Another advantage resides in more accurate population classification or grouping of a genetic data set.

Another advantage resides in providing a population classification framework that is readily extendible to more finely resolved population groupings (i.e. extendible to defining sub-populations).

Another advantage resides in performing population classification or grouping of a genetic data set based on the aggregate genetic data set rather than based on predetermined discrete genetic markers.

Another advantage resides in performing population classification with reduced computational complexity, e.g. using a precomputed linear transformation without performing de novo feature reduction for each sample to be classified.

Numerous additional advantages and benefits will become apparent to those of ordinary skill in the art upon reading the following detailed description.

The invention may take form in various components and arrangements of components, and in various process operations and arrangements of process operations. The drawings are only for the purpose of illustrating preferred embodiments and are not to be construed as limiting the invention.

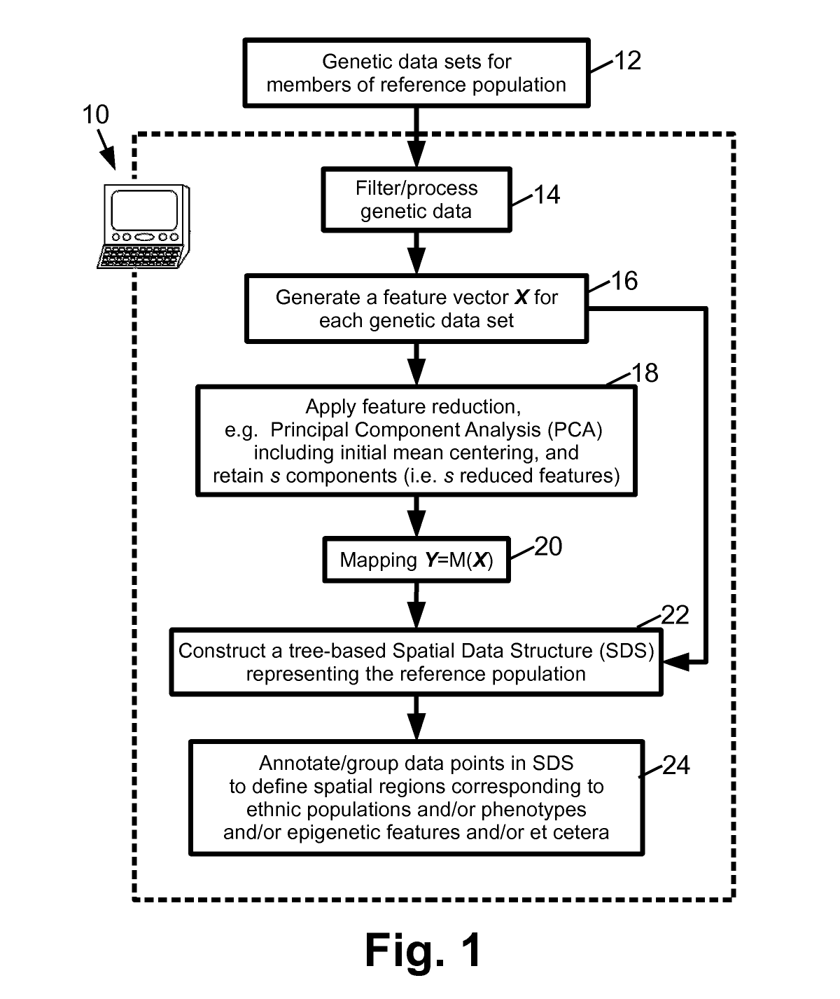

FIG. 1 diagrammatically shows a system for generating a population classifier employing a tree-based Spatial Data Structure (SDS).

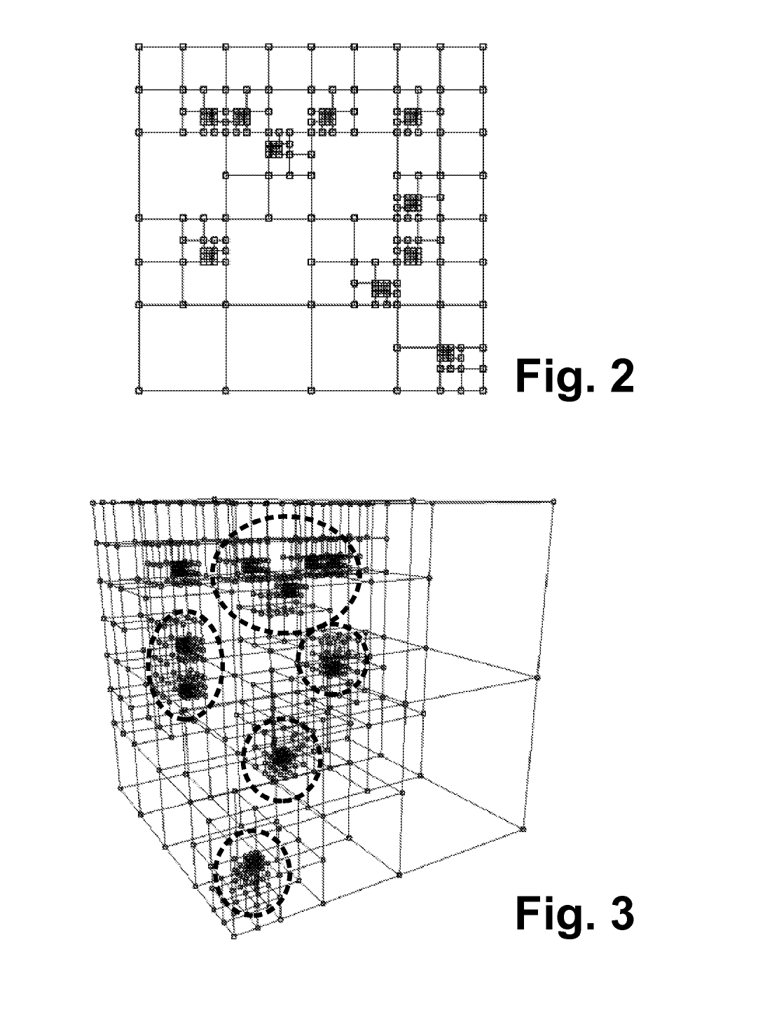

FIG. 2 diagrammatically shows an illustrative quadtree structure suitably generated by the system of FIG. 1 when two-dimensional data points are used.

FIG. 3 diagrammatically shows an illustrative octree SDS suitably generated by the system of FIG. 1 when three-dimensional data points are used.

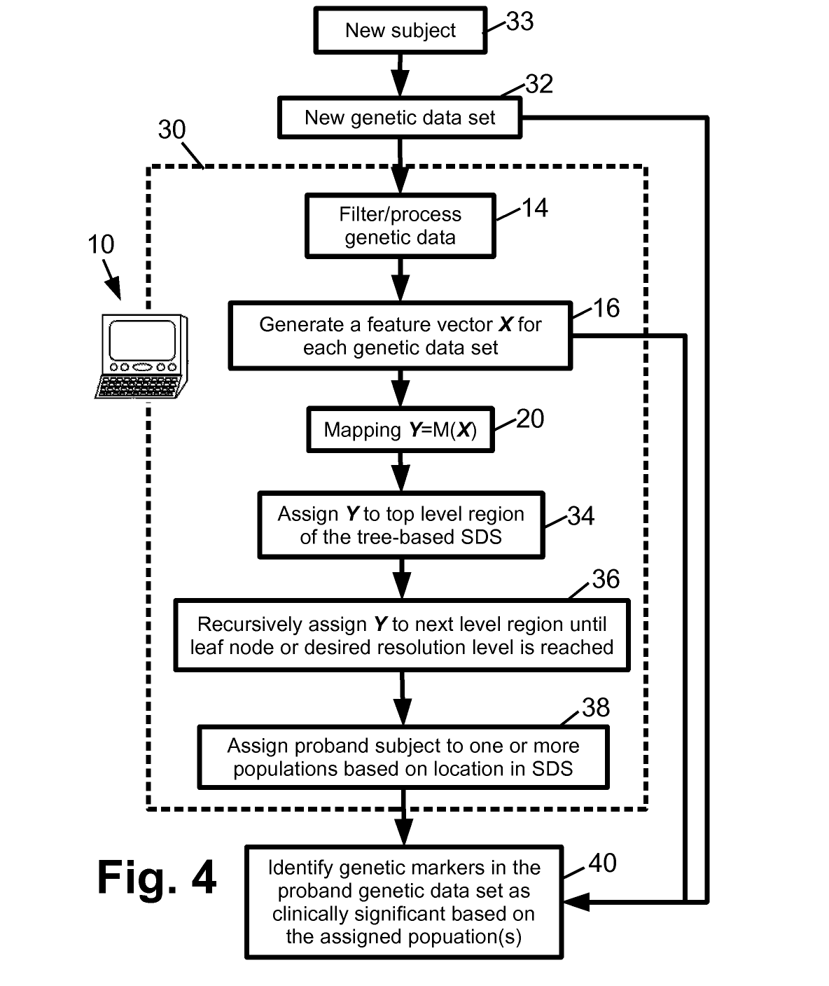

FIG. 4 diagrammatically shows operation of a population classifier generated by the system of FIG. 1.

With reference to FIG. 1, a system for generating a population classifier for classifying a genetic data set is diagrammatically shown. The system is suitably implemented by a computer or other electronic data processing device 10 programmed to perform the disclosed processing operations, and receives as input a plurality of genetic data sets 12 for members of a reference population. The genetic data sets can, for example, include genetic sequencing data (nuclear DNA, mitochondrial DNA, RNA, methylation data, or so forth), protein expression data generated using a microarray or other laboratory processing. In some embodiments the genetic data sets 12 include whole genome sequence WGS data sets or other substantial genetic sequences generated by next-generation sequencing apparatus. The genetic data sets 12 optionally may include genetic data of more than one type, e.g. both sequencing data and microarray data. The genetic data sets 12 are substantially overlapping (i.e., include the same genetic regions, results from the same standard microarray, or so forth) and undergo standardized filtering and/or processing 14. By “standardized” it is meant that the genetic data sets 12 all undergo the same filtering and/or processing 14, which may by way of illustrative example include identification of single nucleotide polymorphisms (SNPs) or other genetic variants like copy number variations (CNVs) etc, normalization of gene expression quantities, binarization (or more generally discretization) of data, removal of outliers, or so forth. In an operation 16 a standardized feature vector X is generated for each filtered/processed reference genetic data set. By “standardized” it is meant that each feature vector X has the same number of dimensions (i.e., the same dimensionality) with corresponding vector elements, e.g. if vector element x₃ represents a particular SNP in one feature vector then vector element x₃ also represents the same SNP in all other feature vectors. The output of operations 14, 16 is a set of feature vectors X corresponding to and representing the set of reference genetic data sets 12. Thus, if there are m individuals in the set of reference genetic data sets 12, then there are m corresponding feature vectors.

In general, the feature vectors X may be of high dimensionality, e.g. each feature vector X containing hundreds, thousands, tens of thousands, or more features (i.e. vector elements). From the genomics literature, various features may be identifiable as being correlative or anti-correlative with certain populations, where a population as used herein broadly encompasses any probative grouping of individuals. Some examples of populations include ethnic populations, gender populations, epigenetic populations, disease populations (e.g., persons with diabetes), disease propensity populations (that is, persons whose genetic makeup predisposes them toward contracting a certain disease), or so forth. Populations of interest can be defined by intersections of populations, e.g. a population of interest may be the intersection of the central European ethnicity population and the female gender population (that is, the population of females of central European ethnicity). Populations of interest can be sub-populations of larger encompassing populations, e.g. the Indian population can be divided into various ethnic populations such as Punjabis, Bengalis, et cetera.

It is recognized herein, however, that reliance upon predetermined discrete genetic markers for assigning subjects to populations has numerous deficiencies. The resulting classifications may become outdated as new genetic research refines or corrects previously determined genetic marker associations. Classifications based on predetermined discrete genetic markers are also not readily extendible to new and different population groupings that may become of interest over time. The strength of correlation between discrete markers and various populations may also be weak in some cases, or a given subject may have mutually contradictory genetic markers (e.g., marker A may indicate the subject belongs to population P whereas marker B may indicate the subject does not belong to population P, making the assignment ambiguous).

The disclosed population classification techniques do not rely upon predetermined discrete genetic markers, but rather instead are based on the aggregate genetic data set. Toward this end, the genetic data set is represented as a reduced dimensionality vector representation which is indexed using a tree-based spatial data structure (SDS). The reduced dimensionality can be achieved using substantially and feature reduction algorithm, such as principal component analysis (PCA), exploratory factor analysis (EFA), multidimensional scaling (MDS), kernel principal component analysis (KPCA), or so forth. The resulting reduced dimensionality vector representation has vector elements or components whose values “blend together” or “mix” features of the feature vector X. The resulting reduced dimensionality vector representations are indexed in a tree-based spatial data structure (SDS) which provides an efficient mechanism for identifying and grouping subjects that are genetically similar. A population of genetically related individuals (e.g., an ethnic population) is therefore expected to be spatially localized in the tree-based SDS.

With continuing reference to FIG. 1, the dimensionality reduction is suitably performed using a mapping or linear transformation of the form is Y=M(X) where X is a feature vector representing a genetic data set (e.g., output by the operation 16), Y is the reduced-dimensionality vector representation of the genetic data set, and M is a transformation matrix. Toward this end, a feature reduction operation 18 is applied, such as such as principal component analysis (PCA), exploratory factor analysis (EFA), multidimensional scaling (MDS), kernel principal component analysis (KPCA), or so forth.

By way of illustrative example, PCA is employed in the illustrative feature reduction operation 18. When PCA is applied in conjunction with mean subtraction (i.e. mean centering), the PCA components corresponds to directions of large variance in the input data set. The PCA components are uncorrelated variables known as principal components. By suitable selection of the dimensionality of the matrices, the PCA can be chosen to generate any number of principal components. The PCA operation 18 (with mean centering) thus generates the linear transformation matrix M which operates on a feature vector X (or a set of such vectors arranged as rows of a matrix) and outputs a reduced dimensionality vector representation Y (or a set of reduced dimensionality vector representations arranged as rows of a matrix if the input X is a matrix of feature vectors). In principle, the linear transformation matrix M could be constructed manually; however, using PCA or another feature reduction technique provides an automated approach for constructing the linear transformation matrix M such that the elements of the output reduced dimensionality vector representation(s) have vector elements that are highly discriminative for distinguishing different genetic populations. (For example, in PCA this discriminativeness comes from the principal components maximizing the variance).

For most feature reduction algorithms (including PCA), the feature reduction operation 18 can be chosen to output the reduced dimensionality vector representation Y with any chosen number of dimensions. To achieve the desired blending or mixing of genetic features stored in the feature vectors X, as well as to provide computational efficiency, it is preferable for the dimensionality of the reduced dimensionality vector representation(s) Y to be reduced as compared with the dimensionality of the feature vectors X. Said another way, the feature reduction 18 operates on feature vectors X representing the genetic data sets 12 of the reference population to generate the mapping 20 which maps the feature vectors X to a vector space of reduced dimensionality as compared with the dimensionality of the feature vectors X. As the amount of feature reduction is increased (corresponding to more reduced dimensionality, i.e. reduced dimensionality vector representation Y with fewer dimensions), both the blending or mixing of features and the computational efficiency are improved. In some embodiments, the reduced dimensionality vector representation Y has two or three dimensions, although higher dimensionality for the reduced dimensionality vector representation Y is contemplated.

The feature reduction operation 18 generates the mapping or linear transform 20 suitably of the form Y=M(X) where X is a feature vector representing a genetic data set, Y is the reduced-dimensionality vector representation of the genetic data set, and M is the transformation matrix. In effect, the feature reduction operation 18 serves to optimize the transformation matrix M to maximize the discriminativeness of the elements of reduced-dimensionality vector representation Y for the set of feature vectors X representing the genetic data sets 12 of the reference population. This optimization is typically done for a chosen dimensionality of the reduced-dimensionality vector representation Y (although it is contemplated to employ a feature reduction algorithm that optimizes dimensionality of the reduced-dimensionality vector representation Y). Thereafter, the mapping 20 can be applied to each feature vector X of the reference population to generate corresponding reduced dimensionality vector representations Y. (In the interest of computational efficiency, this transformation can be done in a single matrix operation in which the linear transformation M operates on a matrix whose rows are the feature vectors of the reference population). Again, if the reference population includes m individuals, these are represented by m feature vectors X generated by the operations 14, 16, and these m feature vectors X are used in the feature reduction operation 18 to optimize the mapping 20, and finally these m feature vectors X are transformed by the mapping 20 (either individually or by operating on a matrix whose m rows are the m feature vectors X) to generate a corresponding m reduced dimensionality vector representations Y.

With continuing reference to FIG. 1 and with brief further reference to FIGS. 2 and 3, in an operation 22 a tree-based spatial data structure (SDS) is constructed which indexes the m reduced dimensionality vector representations Y. A tree-based SDS is constructed using a recursive spatial partitioning algorithm to partition a vector space. Some known tree-based SDS include quadtree structures (see FIG. 2; applicable to two-dimensional vector spaces and recursively partitioning each spatial region into four parts), octree structures (see FIG. 3; applicable to three-dimensional vector spaces and recursively partitioning each spatial region into eight parts), hypertree structures (i.e., generalizing for higher than three dimensions), k-d tree structures, UB-tree structures, and so forth. Tree-based SDS are well-known for use in geographic information systems (GIS) applications (e.g., computerized geographic mapping applications that enable zooming in and out), because the tree-based SDS enables one to efficiently “drill down” from a coarse spatial resolution to a fine local resolution. Advantageously (and as diagrammatically illustrated in the quadtree and octree structures of respective FIGS. 2 and 3), in some SDS indexes the number of levels of the recursive partitioning can vary locally. In GIS applications, for example, the recursive partitioning may be performed for a higher number of levels (giving finer spatial resolution) in densely populated cities, whereas the recursive partitioning may be performed for fewer levels (giving coarser spatial resolution and requiring less memory or storage) in sparsely populated or unpopulated areas having few features of interest.

Another advantage of a tree-based SDS in GIS applications is that it is readily adjusted to increase spatial resolution in areas of population growth. This can be done by applying additional recursive partitioning (i.e. adding more levels) to the region or regions representing the geographical area of high population growth. Conversely, if memory or storage is at a premium, areas of population decline can be modified by merging “leaf” regions of the SDS to “undo” the latter recursions of the recursive spatial partitioning.

The operation 22 constructs a tree-based SDS to index the m reduced dimensionality vector representations Y of the m individuals of the reference population. The tree-based SDS automatically operates to group individuals with similar genetic make-up (as represented by their reduced dimensionality vector representations Y) in the same spatial partition or region, or in contiguous spatial partitions or regions.

In some embodiments, the tree-based SDS construction operation 22 constructs the tree-based SDS with the same number of dimensions as the dimensionality of the reduced dimensionality vector representations Y. For example, if the reduced dimensionality vector representations Yhave three dimensions, then in these embodiments the constructed tree-based SDS also has three dimensions (and may, for example, be an octree).

Alternatively, the tree-based SDS construction operation 22 may construct the tree-based SDS with fewer dimensions than the dimensionality of the reduced dimensionality vector representations Y. For example, if the reduced dimensionality vector representations Yhave three dimensions, then in these embodiments the constructed tree-based SDS may have only two dimensions (and may, for example, be a quadtree). In the case of PCA, the first principal component typically has the maximum variance (for the training population, in this case the reference population), the second principal component has the next-highest variance, and so forth. Hence, if fewer than all of the dimensions of PCA-generated reduced dimensionality vector representations Y are used in constructing the tree-based SDS, it is generally advantageous to use the “first-N” principal components.

The operation 22 thus stores the reduced-dimensionality vector representations of the genetic data sets 12 of the reference population as (reference) data points in a tree-based spatial data structure. These data points may have the same number of dimensions as the reduced-dimensionality vector representations (in which case the reduced-dimensionality vector representations essentially “are” the data points). Alternatively, the data points may have fewer dimensions than the reduced-dimensionality vector representations, for example with each data point being represented by the first two principal components of a three (or more) dimensional PCA-generated reduced-dimensionality vector representation. The constructed tree-based SDS may be any structure comporting with the dimensionality of the data points, e.g. a quadtree structure (for indexing two-dimensional data points), an octree structure (for indexing three-dimensional data points), a k-d tree structure, a UB-tree structure, or so forth.

In an operation 24, the (reference) data points indexed by the tree-based SDS are annotated, grouped, or otherwise labeled to define ethnic populations, phenotype populations, or other populations of interest. Generally, the operation 24 involves annotating the data points in the tree-based SDS with information about subjects from which the genetic data sets of the reference population were acquired, and associating spatial regions of the tree-based SDS with populations within the reference population based on the distribution of data points and their annotations. The associating may entail performing clustering of the annotated data points in the space indexed by the tree-based SDS. Suitable clustering algorithms include, by way of illustrative example, k-means clustering, k-medoid clustering, or so forth. The k-medoid clustering technique is generally more tolerant of outliers than k-means clustering.

With reference to the octree structure of illustrative FIG. 3, the spatial nature of the tree-based SDS means that clusters of genetically similar data points form contiguous regions in the vector space. In illustrative FIG. 3, five illustrative clusters are diagrammatically indicated by dashed circles. (Note that since the octree structure is three-dimensional, these clusters are actually three-dimensional, e.g. spheres, ellipsoids, some irregular shape, or so forth). Performing the clustering in the tree-based SDS can be advantageous since, for example, identifying N nearest neighbors to a data point can be done by counting points in the leaf node of the tree-based SDS that contains the data point and then expanding outward to higher levels until N neighbors are identified (which are nearest neighbors due to the spatial nature of the tree-based SDS).

The output of the system of FIG. 1 is a population classifier that includes the mapping 20 and the tree-based SDS and its indexed reference points generated by the operations 22, 24. The mapping 20 may advantageously be implemented as a linear transformation, e.g. using a matrix-based mapping formulation Y=M(X) where M is a transformation matrix.

With reference to FIG. 4, operation of a population classifier 30 generated by the system of FIG. 1 is described. The population classifier 30 is suitably implemented by a computer 10, which may be the same computer as the one on which the system of FIG. 1 is implemented, or a different computer. The input to the population classifier 30 is a new genetic data set 32 extracted from a “new” individual 33 who is typically (although not necessarily) not a member of the reference population. (It should be noted that an individual or subject as used herein is typically a human individual or subject as is the case for genetic medical tests, human population studies, or so forth; however, more generally an individual or subject as used herein may be an individual animal or animal subject, as is suitably the case in pre-clinical testing or veterinary practice, or may be a mummy or other deceased human or animal subject, as is suitably the case in post-mortem forensic genetic testing, archaeological mummy testing, or so forth).

In general, the new subject 33 may be a proband subject, that is, a particular individual or subject under study or to be the subject of a genetic analysis report.

Alternatively, the new subject 33 may be an additional reference subject being added to update the population classifier. Advantageously, the disclosed population classifier techniques are readily updated with new subjects or individuals, with the tree-based SDS partitioning resolution (i.e., number of levels) increased as needed to accommodate higher population densities in various regions of the tree-based SDS and any updating of the population regions being optionally localized to the regions in which the new individuals are added. The resolution may also be increased by further partitioning if new medical studies indicate that finer-resolution population definitions (e.g., defining sub-populations) is useful for a certain genetic analysis.

The new genetic data set 32 is processed by the filtering/processing operations 14 and the feature vector generation operation 16 to generate a feature vector X representing the new genetic data set 32. These are the same operations 14, 16 that are applied to the reference genetic data sets 12 in the system of FIG. 1, so that the feature vector representing the new genetic data set 32 is comparable with the feature vectors representing the reference population. That is, the feature vector representing the new genetic data set 32 is a standardized feature vector having the same number of dimensions (i.e., the same dimensionality) with corresponding vector elements as compared with the feature vectors representing the reference population.

With continuing reference to FIG. 4, this standardized feature vector representing the new genetic data set 32 is then transformed using the mapping 20 that was optimized by the feature reduction operation 18 performed by the system of FIG. 1. This transformation generates a reduced dimensionality vector representation Y of the new genetic data set 32, which by virtue of being generated by the standard mapping 20 has the same dimensionality and corresponding vector elements as compared with the reduced dimensionality vector representations of the reference genetic data sets 12 of the reference population. Accordingly, the reduced dimensionality vector representation Y of the new genetic data set 32 can be located in the tree-based SDS using a “drill down” process 34, 36. In operation 34, the reduced dimensionality vector representation Y of the new genetic data set 32 is assigned to (i.e. located in) the top-level region of the tree-based SDS. In operation 36, the reduced dimensionality vector representation Y of the new genetic data set 32 is recursively assigned to each next-lower level of the tree-based SDS until a stopping criterion is met—for example reaching a leaf node of the tree-based SDS or reaching a desired spatial resolution. The operation 36 is computationally efficient due to the recursive partitioning used to generate the tree-based SDS. At any given level, the location of Y in the next-lower level is necessarily in one of the partitions (i.e., “sub”-regions) of the region of the current level containing Y. For a quadtree structure, there are only four (sub-)regions to search; for an octree structure there are eight regions to search; and et cetera.

With continuing reference to FIG. 4, if the new subject 33 is a proband subject then in an operation 38 the proband subject is assigned to one or more populations based on the location of the reduced dimensionality vector representation Y of the new genetic data set 32 in the tree-based SDS. Due to the spatial nature of the tree-based SDS a population typically corresponds to a spatial region, i.e. to one or more contiguous regions of the tree-based SDS. Thus, if the reduced dimensionality vector representation Y of the new genetic data set 32 lies in this spatial region or contiguous group of regions, then the new subject 33 is assigned to that population. (It should be noted that a given region may belong to more than one population, e.g. a given region may belong to the Indian ethnic population, the Bengali (sub-)population, the female gender population, and so forth.

The dimensional reduction of the reduced dimensionality vector representation Y (as compared with the feature vector X) means that the reduced dimensionality vector representation Y does not contain all the original genetic information. Accordingly, the reduced dimensionality vector representation Y is not a suitable data set for performing genetic analyses such as identifying specific SNPs or other specific genetic markers. Rather, the reduced dimensionality vector representation Y is used for the population assignment. A subsequent genetic analysis 40 is typically performed to identify SNP's, gene expression levels, or other genetic markers that are indicative of disease or other phenotype characteristics for a population to which the proband subject is assigned. The genetic analysis 40 may operate on the feature vector X, in which case the processing operations 14, 16 are leveraged in the subsequent genetic analysis 40. Additionally or alternatively, the original genetic data set 32 may be utilized (as may be appropriate if, for example, the filtering 14 may have discarded SNPs of interest).

The genetic analysis 40 is performed if the new subject 33 is a proband subject. If, on the other hand, the new subject 33 is a new reference subject for updating the population classifier, then the location operations 34, 36 are suitably followed by population classifier update operations. For example, the data point corresponding to (or, in some embodiments, identical with) the reduced dimensionality vector representation Y of the new genetic data set 32 may be added to the tree-based SDS at its appropriate location and annotated with information known about the new reference subject 33. Populations to which the new reference subject 33 belongs may be re-clustered or otherwise redefined or adjusted to account for the new information represented by the reduced dimensionality vector representation Y of the new genetic data set 32 and its annotations.

In the foregoing description, it has generally been assumed that each genetic data set corresponds to an individual subject. However, it is to be appreciated that in some cases a single individual may be the source of two or more different genetic data sets. For example, a cancer patient may have genetic samples acquired from healthy tissue to generate a healthy tissue genetic data set, and from a malignant tumor to generate a disease genetic data set. In such a case the healthy and disease genetic data sets are processed individually and define separate data points that can each be located in the tree-based SDS, with the distance between them being indicative of genetic differentiation between the healthy and diseased tissues.

In illustrative FIGS. 1 and 4 the described systems are implemented by the computer or other electronic data processing device 10. It is also to be understood that these systems and the disclosed population assignment techniques can be implemented by a non-transitory storage medium storing instructions executable by an electronic data processing device to perform the disclosed operations. For example, the non-transitory storage medium may be a hard disk drive or other magnetic storage medium, or an optical disk or other optical storage medium, or random access memory (RAM), read-only memory (ROM), flash memory, or another electronic storage medium; various combinations thereof; or so forth.

The disclosed population assignment techniques provide an efficient mechanism, namely the tree-based SDS, for storing population cluster data, and, by virtue of this storage mechanism, provides a robust method of quickly classifying a newly sequenced, genotyped, or otherwise acquired genetic data set. In the case of research or clinical applications where it may be advantageous to know which individuals are similar genetically in terms of population of origin to a proband individual, the disclosed approaches provides a way to present such information without divulging the actual genetic sequence or signatures of the reference individuals, which may be desirable for privacy of genetic data.

When the disclosed methods are employed for comparing diseased and normal samples from the same tissue of origin, genetic analysis of neighboring samples in the tree-based SDS may elaborate about the possible mode of pathogenesis in the proband sample. For example, if different genes of the same pathway are involved in the neighboring samples, the same pathway may be involved in the proband sample.

In the disclosed approaches, the whole pipeline does not need to be re-executed for classifying the sample, thereby saving time and computational resource. In particular, the computationally intensive feature reduction operation 18 is performed only once; thereafter, the computationally efficient linear transformation M is applied. In view of this computational efficiency, the disclosed approaches are readily applied as fast screening methods for determining whether a sample belongs to a disease class coupled with the population information.

In the following, some further illustrative examples are described.

In one example, genome sequence information from multiple individuals from diverse global populations are collected and SNP calls are made at select positions extracted under accepted rules. For example, the minor allele frequency (MAF) of such an SNP should be above a threshold value in each population, there should not be many missing calls, the SNPs should be sufficiently separated so as to be free of linkage disequilibrium among themselves, and so forth. The genetic data are recoded numerically using accepted rules to generate the feature vectors X. This global dataset is then subjected to PCA or another dimensionality reduction (e.g., factor analysis) procedure e.g. multidimensional scaling (MDS), kernel PCA (KPCA), or so forth to generate a mapping M which is then applied to the feature vectors X to generate reduced dimensionality vector representations Y. A first few dimensions of Y contributing to maximum variations in the dataset (or all dimensions of Y, if the dimensional reduction is aggressive) are selected (three to four dimensions are contemplated in some embodiments) and are stored in a tree-based spatial data structure (SDS) such as a k-d tree structure, octree structure, UB-tree structure, or so forth. This processing generates the population classifier.

For a newly sequenced sample, the same mapping M from the high dimensional data to lower dimensionality transformed dataset (which had been computed for the reference data set) is used. Under the assumption that the reference dataset is a suitably comprehensive data set (i.e., a “global” dataset), the new sample would belong to one of the original population clusters and would not introduce too much additional variance in the dataset and the mapping would approximately correctly place the new sample in the transformed space thus avoiding the complex computation of re-doing the dimensionality reduction procedure afresh. Using the reduced dimensionality vector representation of the new sample the original (i.e. reference) dataset is queried and information such as population membership of this sample, its closest neighboring individuals, or so forth is retrieved.

The population of sample genotypes is typically expected to be distributed non-uniformly in the reduced-dimensionality vector space. Such non-uniform distribution is readily accommodated by the tree-based SDS as the recursive partitioning can be tailored to accommodate the spatial distribution. Suitable tree-based SDS include an octree for three principal components chosen, or a hypertree for >3 principle components chosen.

In the following, a processing workflow example is described.

First, multiple unrelated individuals from different global populations are collected so as not to exclude any significant population from which a potential newcomer to be tested later may arise. These individuals form the reference data.

Second, sequencing or genotyping information are acquired of these individuals for whole-genome SNPs.

Third, the SNPs are filtered so that in each subpopulation each SNP: (a) have a MAF (minor/minimum allele frequency) ≧0.05 (not to include rare SNPs which could amount to be outliers and skew the analysis); (b) have missing genotypes <10% (redundant if the information is from sequencing: ideally there should not be missing information in that case); and (c) are in the Hardy-Weinberg Equilibrium (HWE) (to include only SNPs stable in a population, i.e. free of significant selection pressure and not associated with obvious survival traits).

Fourth, the SNPs are recoded numerically using the following conversion: [AA, AD, DD]→[2, 1, 0]; where ‘A’ is the major allele for the SNP considering all reference individuals and ‘D’ the minor allele. In case of variants like CNVs with more than three possible diploid genotypes, they may be similarly discretized; e.g. [Copy number states 0, 1, 2, 3, 4, 5 ]→[0, 1, 2, 3, 4, 5]

Fifth, if there are m individuals and n SNP genotypes, the data can be represented as a mxn matrix X with one individual genotype being represented along one row of X.

Sixth, for each numerically coded SNP, the mean is calculated and X is mean-centered to X′ with the relation X-X_{M}=X′ (where X_{M} is the mean).

Seventh, principal component analysis (PCA) is performed to obtain an mxl matrix Y, where 1≦1≦n. The first few principal components contributing to most variance (usual standards e.g. eigenvalue >1 or by scree analysis) in the data are selected for storage, e.g. stored as Y′which is a m×3 matrix if only the first three principle components are stored.

Either, the fifth through seventh operations are represented as Y′=M(X) when M is the mapping from X to Y′. (This holds true for other dimensionality reduction procedures e.g. EFA/MDS, KPCA, et cetera).

Ninth, the matrix Y′ is used to store annotation information for the individuals, for example demographic information such as population of origin, geography of origin, or so forth, using the three principal component values from Y′ as coordinates in a three-dimensional tree-based spatial data structure (SDS). An octree structure is suitable for three principal component values. This is then used as the reference databank against which new samples are compared. Clusters {C₁, C₂, . . . , Cₘ} are computed or determined over the data points in the tree-based SDS with a set of m-number of cluster representatives (centroids/medoids).

Tenth, when a newcomer individual genotype G is available, it is transformed to the principal component space with the mapping M as G′=M(G) with M being exactly the same as in Y′=M(X). As the PCA (or other feature reduction) is avoided and only matrix algebra with pre-calculated values is involved, this transformation is computationally efficient and takes approximately constant time.

Eleventh, from the coordinates obtained in G′, the data stored in the tree-based SDS is queried efficiently to provide various information, for example: (a) which population cluster G belongs to, if any (here the tree-based SDS is queried to determine if G belongs to one of the clusters {C₁, C₂, . . . , Cₘ}) and/or (b) which individuals are nearest to G (here k-nearest individuals to G are determined using a K-NN search algorithm performed over the tree-based SDS) and/or (c) demographic annotation information of the neighboring individuals and/or et cetera.

Twelfth, in the case of individuals from different populations we have genotype information from normal and different cancer samples or other (e.g. degenerative disease) disease samples from the same tissue of origin, similar method may be employed.

Thirteenth, if a newcomer individual comes from a new population, the PCA may be performed again and error matrix calculated (see “Model identification and error covariance matrix estimation from noisy data using PCA”, S. Narasimhan and S.L. Shah, Control Engineering Practice, vol. 16, no. 1, January 2008, Pages 146-155). If required, more principal components may be included in the new reference data.

The invention has been described with reference to the preferred embodiments. Obviously, modifications and alterations will occur to others upon reading and understanding the preceding detailed description. It is intended that the invention be construed as including all such modifications and alterations insofar as they come within the scope of the appended claims or the equivalents thereof.

1. A non-transitory storage medium storing instructions executable by an electronic data processing device to perform a method comprising:
performing feature reduction on feature vectors representing genetic data sets of a reference population to generate a mapping that maps the feature vectors to a vector space of reduced dimensionality as compared with the dimensionality of the feature vectors;
generating reduced-dimensionality vector representations of the genetic data sets of the reference population using the mapping;
storing the reduced-dimensionality vector representations of the genetic data sets of the reference population as data points in a tree-based spatial data structure;
annotating the data points in the tree-based spatial data structure with information about subjects from which the genetic data sets of the reference population were acquired; and
associating spatial regions of the tree-based spatial data structure with populations within the reference population based on the distribution of data points and their annotations.

2. The non-transitory storage medium of claim 1, wherein the mapping is a linear transformation.

3. The non-transitory storage medium of claim 1, wherein the mapping is Y=M(X) where X is a feature vector representing a genetic data set, Y is the reduced-dimensionality vector representation of the genetic data set, and M is a transformation matrix.

4. The non-transitory storage medium of claim 1, wherein the performing comprises:
performing principal component analysis (PCA) on the feature vectors representing the genetic data sets of the reference population to generate the mapping.

5. The non-transitory storage medium of claim 1, wherein the tree-based spatial data structure has dimensionality equal to the dimensionality of the reduced-dimensionality vector representations of the genetic data sets of the reference population.

6. The non-transitory storage medium of claim 1, wherein the tree-based spatial data structure has dimensionality lower than the dimensionality of the reduced-dimensionality vector representations of the genetic data sets of the reference population, and the storing comprises:
storing the reduced-dimensionality vector representations of the genetic data sets of the reference population as data points having coordinates defined by less than all of the dimensions of the reduced-dimensionality vector representations of the genetic data sets of the reference population.

7. The non-transitory storage medium of claim 1, wherein the tree-based spatial data structure is a quadtree structure, an octree structure, a k-d tree structure, or a UB-tree structure.

8. The non-transitory storage medium of claim 1, wherein the method further comprises:
generating a new reduced-dimensionality vector representation of a new genetic data set that is not part of the reference population using the mapping; and
storing the new reduced-dimensionality vector representation as a new data point in the tree-based spatial data structure.

9. (canceled)

10. The non-transitory storage medium of claim 1 , wherein the associating comprises:
performing clustering of the annotated data points in the space indexed by the tree-based spatial data structure.

11. The non-transitory storage medium of claim 10, wherein the clustering is k-medoid clustering.

12. The non-transitory storage medium of claim 1, wherein the method further comprises:
generating a proband reduced-dimensionality vector representation of a proband genetic data set using the mapping;
locating the proband reduced-dimensionality vector representation in the tree-based spatial data structure; and
classifying the proband genetic data set based on its location in the tree-based spatial data structure.

13. An apparatus comprising:
a non-transitory storage medium as set forth in claim 1; and
an electronic data processing device-configured to read and execute instructions stored on the non-transitory storage medium.

14. A method comprising:
constructing a feature vector representing a genetic data set;
reducing dimensionality of the feature vector using a linear transformation to generate a reduced-dimensionality vector representation of the genetic data set;
locating the reduced-dimensionality vector representation of the genetic data set in a tree-based spatial data structure, wherein the locating comprises:
identifying annotated data points in the tree-based spatial data structure with information about subjects from which the genetic data set of a reference population was acquired; and
making associations between spatial regions of the tree-based structure data with populations within the reference population based on the distribution of data points and their annotations; and
assigning the genetic data set to one or more populations based on the location of its reduced dimensionality vector representation in the tree-based spatial data structure;
wherein at least the constructing, generating, and locating are performed by an electronic data processing device.

15. The method of claim 14, further comprising:
identifying one or more genetic markers in the genetic data set as clinically significant based on the one or more populations to which the genetic data set is assigned.

16. The method of claim 14, further comprising:
(i) constructing reference feature vectors representing reference genetic data sets of a reference population;
(ii) reducing dimensionality of the reference feature vectors using the linear transformation to generate reduced-dimensionality vector representations of the reference genetic data sets of the reference population; and
(iii) constructing the tree-based spatial data structure to index the reference genetic data sets as data points defined by at least some dimensions of the reduced-dimensionality vector representations of the reference genetic data sets of the reference population;
wherein the operations (i), (ii), and (iii) are performed by the electronic data processing device.

17. The method of claim 16, further comprising:
performing feature reduction on the reference feature vectors the linear transformation, the feature reduction being performed by the electronic data processing device.

18. The method of claim 17, wherein the feature reduction is one of principal component analysis (PCA), exploratory factor analysis (EFA), multidimensional scaling (MDS), and kernel principal component analysis (KPCA).

19. An apparatus comprising:
an electronic data processing device programmed to:
construct reference feature vectors representing reference genetic data sets of a reference population,
transform the reference feature vectors using a linear transformation to generate reduced-dimensionality vector representations of the reference genetic data sets of the reference population,
construct a tree-based spatial data structure to index the reference genetic data sets as data points defined by at least some dimensions of the reduced-dimensionality vector representations of the reference genetic data sets of the reference population,
annotate the data points in the tree-based spatial data structure with information about subjects f rom which the genetic data sets of the reference population were acquired; and
associate spatial regions of the tree-based spatia data structure with populations within the reference population based on the distribution of data points and their annotations.

20. The apparatus of claim 19, wherein the electronic data processing device is further programmed to perform feature reduction on the reference feature vectors using the linear transformation.

21. The apparatus of claim 19, wherein the electronic data processing device is further programmed to:
transform a feature vector representing a proband genetic data set using the linear transformation to generate a reduced-dimensionality vector representation of the proband genetic data set,
locate the reduced-dimensionality vector representation of the proband genetic data set in the tree-based spatial data structure, and
assign the proband genetic data set to one or more populations based on the location of its reduced dimensionality vector representation in the tree-based spatial data structure
